(19) United States
(12) Patent Application Publication
(10) Pub. No.: US 2008/0154725 A1
(43) Pub. Date: Jun. 26, 2008

(54) ENGAGEMENT-BASED REWARDS

(75) Inventors: Gary W. Flake, Bellevue, WA (US); Jeffrey R. Hemmen, Renton, WA (US); Alexander G. Gounares, Kirkland, WA (US); David M. Chickering, Bellevue, WA (US); Eric J. Horvitz, Kirkland, WA (US); Michael Connolly, Seattle, WA (US); Lili Cheng, Bellevue, WA (US); Kamal Jain, Bellevue, WA (US); George P. Moromisato, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/959,864

(22) Filed: Dec. 19, 2007

Related U.S. Application Data
(60) Provisional application No. 60/870,926, filed on Dec. 20, 2006.

(51) Int. Cl. G06Q 30/00; G01S 5/00

(52) U.S. Cl. 705/14

(57) ABSTRACT

The claimed subject matter relates to an architecture that can provide engagement-based incentives designed or intended to enrich or extent a shopping session of a shopper. In particular, the architecture can select an incentive and an engagement, each from a respective set potentially received in whole or in part from one or more vendors. The architecture can select the incentive and/or engagement based upon a location of the shopper, a profile of the shopper, or based upon other transactions occurring during a shopping session.

### CROSS-REFERENCE TO RELATED APPLICATIONS

This application claims the benefit of U.S. Provisional Application Ser. No. 60/870,926, filed Dec. 20, 2006, entitled “ARCHITECTURES FOR SEARCH AND ADVERTISING.” This application is related to U.S. application Ser. No. 11/767,360, filed on Jun. 22, 2007, entitled “MOBILE AD SELECTION AND FILTERING.” This application is related to U.S. application Ser. No. 11/959,844, filed on Dec. 19, 2007, entitled “RETAILER COMPETITION BASED ON PUBLISHED INTENT.” This application is related to U.S. application Ser. No. 11/959,874, filed on Dec. 19, 2007, entitled “FEEDBACK LOOP FOR CONSUMER TRANSACTIONS.” The entireties of these applications are incorporated herein by reference.

### BACKGROUND

In conventional retail forums, many vendors favor certain consumer or shopper behavior patterns over other patterns. For example, vendors generally do not want to encourage large amounts of loitering unless such can be reasonably projected to lead to eventual purchases or other desired transactions. On the other hand, the shopper who simply buys a particular product or service and then leaves immediately afterward is also not an optimal behavior pattern from a revenue standpoint of the vendor. Rather, many vendors would prefer to encourage a combination of these two patterns.

In particular, from the perspective of a vendor, a more ideal behavior pattern for shoppers might involve the shopper engaging in a purchase transaction, followed by subsequent browsing in which additional purchases or desired transactions are more likely. Conventionally, vendors often employ incentives such as discounts or prizes to encourage desired transactions, however, currently, incentives are not adequately utilized to promote or facilitate certain types of desired shopper behavior patterns.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one aspect thereof, comprises an architecture that can provide engagement-based incentives intended to extend or enrich a shopping session. To these and other related ends, the architecture can obtain and utilize various data relating to a shopper in order to construct or tailor an engagement-based incentive. Such data can include location information, profile information, recent shopping-based transactions, and so forth, all or portions of which can be obtained by way of a mobile device of the shopper.

The engagement-based incentive can include an incentive portion that provides some type of enticement to the shopper, generally, an economic, intellectual, or entertainment-based enticement. In addition, the engagement-based incentive can include an engagement portion that typically delineates conditions that must be satisfied in order to be eligible for the incentive. Usually, the conditions are time- or location-specific, and can require that the shopper provide some form of feedback

In accordance with an aspect of the claimed subject matter, both the incentive and the engagement can be selected from a set of incentives and a set of engagements, respectively. All or portions of these two sets can be received from suitable vendors, either based upon a real time request to the suitable vendors (e.g., during a shopping session of a particular shopper) or in advance and saved to a data store for potential use with any given shopper. Thus, at appropriate times, the architecture can select an appropriate incentive, select an appropriate engagement, and then combine the two to construct the engagement-based incentive.

In an aspect, the architecture can construct a second engagement-based incentive that is similar to the prior engagement-based incentive, but can be prompted in different ways. In one aspect, the second engagement-based incentive can be in response to a transaction that occurs while a previous engagement-based incentive is still active or redeemable. In another aspect, the second engagement-based incentive can be in response to an indication that the previous engagement-based incentive was adequately satisfied by the shopper. Generally, in the latter case, the second engagement-based incentive can include an incentive that is progressively larger in value than the incentive included in the previous engagement-based incentive.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a block diagram of a system that can provide engagement-based incentives intended to extend or enrich a shopping session.

FIG. 2 illustrates a block diagram of a system that illustrates promotion component 120 in further detail.

FIG. 3 depicts a block diagram of a system that can solicit feedback from shopper 106.

FIG. 4 illustrates a block diagram of a system that illustrates additional features in connection with promotion component 120.

FIG. 5 is example timeline 500 for shopper 106.

FIG. 6 depicts a block diagram of a system which illustrates various example implementations of system 100.

FIG. 7 illustrates a block diagram of a system that depicts features of mapping component 102 and profiling component 108 in further detail.

FIG. 8 depicts a block diagram of a system that can aid with various inferences.

FIG. 9 is an exemplary flow chart of procedures that define a method for generating engagement-based incentives that facilitate prolonging or enhancing a shopping session.

FIG. 10 illustrates an exemplary flow chart of procedures that define a method for employing additional features for creating the engagement-based incentive.

FIG. 11 depicts an exemplary flow chart of procedures defining a method for constructing a second engagement-based incentive in order to facilitate extending or enriching a shopping session.

FIG. 12 is an exemplary flow chart of procedures defining a method for providing engagement-based incentives that facilitate prolonging or enhancing a shopping session.

FIG. 13 illustrates a block diagram of a computer operable to execute the disclosed architecture.

FIG. 14 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system,” or the like can, but need not, refer to a computer-related entity, either hardware, a combination of hardware and software, software, or software in execution. For example, a component might be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms “infer” or “inference” generally refer to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

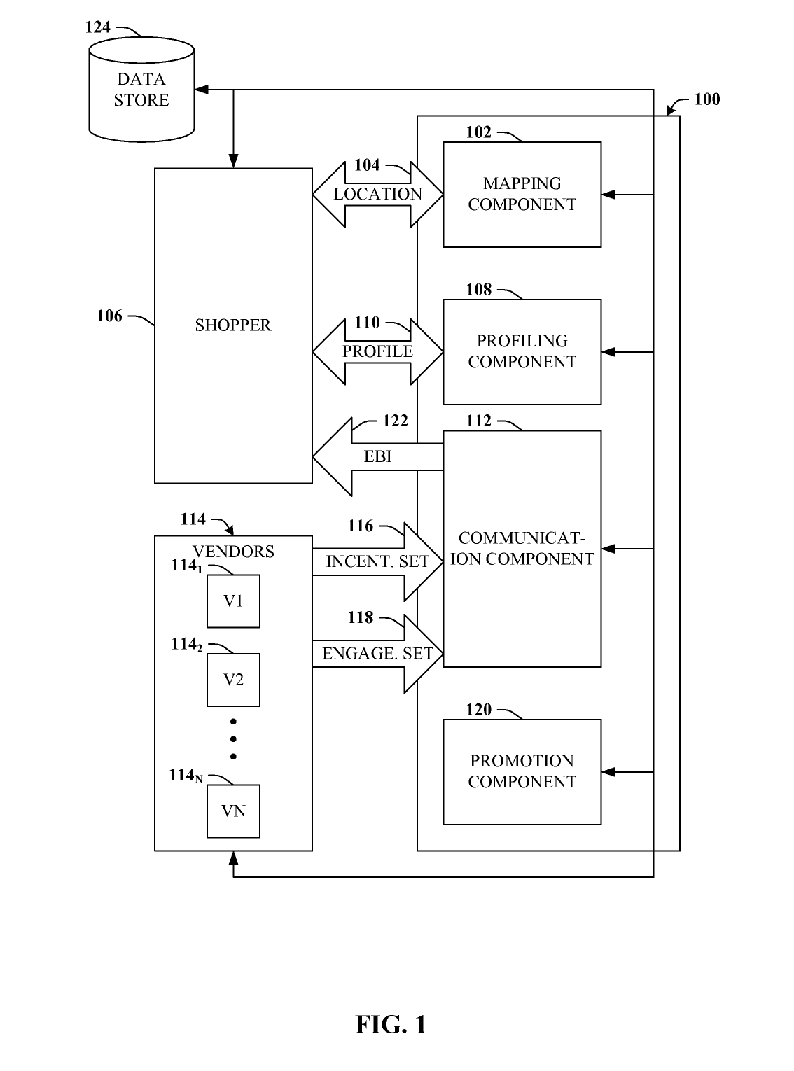

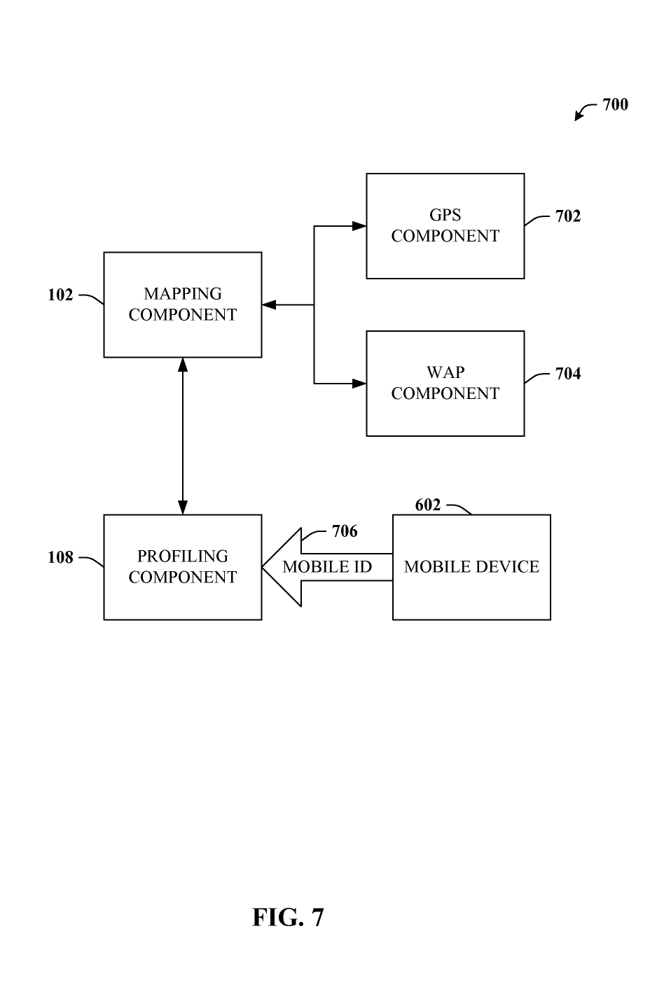

Referring now to the drawings, with reference initially to FIG. 1, system 100 that can provide engagement-based incentives intended to extend or enrich a shopping session is depicted. Generally, system 100 can include mapping component 102 that can determine location 104 of shopper 106. Location 104 is typically a current location of shopper 106, and mapping component 102 can determine location 104 based upon a location where communication occurs with shopper 106 or based upon data received from other components (potentially by way of a mobile device of shopper 106) such as those described in connection with FIG. 7. Shopper 106 can be substantially any individual or entity who uses the subject matter described or claimed herein. According to some aspects, shopper 106 can be a potential customer and is not necessarily limited only to entities or individuals who have made or plan to make a purchase or engage in another related type of transaction. In some aspects, shopper 106 can be an individual or entity who is at a certain location, such as at or near an embodiment of system 100 or at or near a particular business establishment of a vendor (e.g., vendor 114). Hence, shopper 106 can be an entity or individual who patronizes a vendor or nearby locations; is on the premises of the vendor or in relatively close proximity to the premises; or one who receives a special type of incentive (e.g. engagement-based incentive 122), generally irrespective of whether or not shopper 106 makes a purchase; irrespective of whether or not shopper 106 intends to make a purchase; or irrespective of whether or not shopper 106 is actively “shopping.”

In addition, system 100 can also include profiling component 108 that can select profile 110 for shopper 106. Profile 110 can include a variety of information relating to shopper 106, such as that which is expressly described herein as well as other information suitable for or within the spirit of the claimed subject matter. For example, profile 110 can include one or more transaction histories that can relate to substantially any type of consumer transaction such as purchases (e.g., products, services, warranties,), time of purchase, returns, use of coupons, feedback, voting, reviews, or opinions, and so forth.

Additionally, profile 110 can include shopping preferences such as a default shopping mode that, e.g., indicates a style or habits relating to shopping for shopper 106. For example, the shopping preferences can relate to how likely shopper 106 is to spend extra time shopping to ferret out bargains and/or responsiveness to promotions. Furthermore, the shopping preferences can relate to how adverse shopper 106 is to crowded shopping environments, or to particular policies or practices of certain vendors, etc. Naturally, other examples exist, but it should be appreciated that shopping preferences can relate to many aspects of shopper 106 and can be utilized in several ways, as described infra. Moreover, shopping preferences can be input directly by shopper 106, received by way of associated devices (e.g., devices of shopper 106, a vendor, or third party devices) or in some cases inferred based upon, e.g., examination of one or more transaction histories.

Demographic data can also be included in profile 110 such as age, gender, income, as well as hobbies, interests, or viewpoints. As with shopping preferences, some demographic data can be received as input directly from shopper 106 or other suitable sources, or inferred from what is known or can be determined about shopper 106. In addition, it should be understood that one or more user IDs can be associated with shopper 106 and can be included in profile 110. These IDs can represent shopper 106 as well as one or more devices of shopper 106, all or portions of which can be stored as keys on a key ring. Thus, profiling component 108 can select profile 110 based upon receipt of an ID relating to shopper 106 or a device thereof.

In many situations, profile 110 might already exist, e.g., in data store 124, which can be employed to store profile 110 as well as any other data described herein or data that is otherwise suitable and/or relevant. In such a case, profile 110 can be associated with shopper 106 based upon some form of identification or authentication such as a password, code, key, a device, machine, or application ID, or other type of ID, and so on.

In other cases, however, valid identification might not be immediately obtained in order to select profile 110 for shopper 106, or profile 110 might not yet exist. In these situations, profiling component 108 can create profile 110 and populate profile 110 based upon any suitable information available at that time. This can include assigning profile 110 (and by proxy shopper 106) a suitable ID, which can be acquired from a device utilized by shopper 106, or based upon a random number generation, and can further be referenced to other device IDs for devices employed by shopper 106 as well as a global ID unique to shopper 106. In another aspect, profiling component 108 can have access to a set of template profiles (not shown) previously constructed, and can determine or infer the best profile 110 from the set of templates, again based upon any suitable information available at that time. Such information can be obtained directly from shopper 106, obtained from a device of shopper 106 (e.g., mobile device), of a vendor, or obtained from suitable sensors or I/O components.

System 100 can also include communication component 112 that can receive from one or more vendors 114₁-114_{N}, a set 116 of incentives and a set 118 of engagements. It should be understood that vendors 114₁-114_{N} can be referred to herein, either individually or collectively as vendor(s) 114, while appreciating that one vendor 114 might have characteristics that distinguish from a second vendor 114. Moreover, vendor 114 is intended to include retailers, advertisers, or agents thereof, or substantially any business establishment, collection of business establishments that solicit transactions from consumers and/or shopper 106. It should also be understood that all or portions of sets 116, 118 can be received either prior to, or in response to a query stemming from, selection of profile 110. For example, sets 116, 118 can be received in whole or in part as a response to a real time query requesting the sets and/or indicating that such sets will be utilized; or additionally or alternatively, sets 116, 188 can be received in whole or in part in advance of such an occurrence. Accordingly, sets 116, 118 can be aggregated and evolve over time or can be responsive to real time applications in which sets 116, 118 are requested, crafted, or received on the fly.

Incentives included in set 116 can include substantially anything of value or utility to shopper 106 and can relate to economic value, intellectual value, entertainment value, and so forth that can, e.g. enrich a shopping experience. According to various aspects, an incentive can be or include a discount, a coupon, a free gift, redeemable points as well as interesting information, a puzzle, a game piece, a clue, etc. Similarly, engagements included in set 118 can include substantially any condition or constraint that must be satisfied in order to receive or qualify for one or more incentives. Typically, the engagements will place conditions on geographic or temporal aspects of shopper 106 such as visiting a particular location at a particular time or within a certain period, or providing input or feedback within a certain period, or the like. Oftentimes, engagements are directed to potentially extending or prolonging a shopping session, wherein a shopping session can be defined as a continuous period beginning when shopper 106 can engage in transactions with one or more vendors 114 and ending when shopper 106 can no longer engage in transactions with one or more vendors 114 (e.g. stops shopping, goes home, leaves the premises, etc.). Additionally or alternatively, a shopping session can be defined as a period in which an individual or entity can be defined as shopper 106. A shopping session can also be defined as a period identified or designated by shopper 106.

Furthermore, system 100 can include promotion component 120 that can select an incentive from set 116 of incentives, and can further select an engagement from set 118 of engagements. Selection of both the incentive and the engagement can be based at least in part upon one or both of location 104 or profile 110. For example, incentives or engagements originating from vendor 114 whose business establishment(s) are proximate to location 104 or whose inventory or target market segment encompasses aspects of profile 110 can be those that are suitable for selection. After the above-mentioned selections are complete, promotion component 120 can combine the incentive and the engagement to construct engagement-based incentive 122 for shopper 106. As depicted, engagement-based incentive 122 can be transmitted to an interface or an I/O component (not shown) such as a screen or display that is local or proximal to shopper 106. The interface or I/O component can be included in, e.g., a mobile device such as a cellular phone, or a stationary terminal such as a kiosk.

Accordingly, promotion component 120 can select engagement-based incentive 122 such that engagement-based incentive 122 is determined or inferred to entertain or stimulate shopper 106 as well as to potentially enrich or extend a shopping session for shopper 106. Moreover, promotion component 120 can select engagement-based incentive 122 that is determined or inferred to appeal to shopper 106 in a manner consistent with one or both location 104 or profile 110. Accordingly, engagement-based incentive 122 can include conditions (e.g., included in the engagement portion) that must be satisfied within a particular period such as within, say, a 24-hour period, an 8-hour period, a 1-hour period, 5 minutes, etc. or within another defined period such as within a single shopping session.

In accordance therewith, for example, to increase the likelihood that the conditions are satisfied within a single shopping session, and therefore extend or enrich the shopping session, engagement-based incentive 122 can become redeemable only after a relatively short period after it is received or is viewable by shopper 106, such as say, 30 minutes, 1 minute, etc. Furthermore, this valid period in which engagement-based incentive 122 can be redeemed can expire after another relatively short period after it is received or is viewable by shopper 106, such as say, 90 minutes, 5 minutes, etc. In other words, engagement-based incentive 122 can become active or redeemable 30 minutes after being transmitted by communication component 112, and remain so for an hour, before expiring 90 minutes after being transmitted by communication component 112.

It should be appreciated that the foregoing times are merely exemplary and are not necessarily intended to limit the scope of the claimed subject matter to only those times or periods suggested by the above examples, as other suitable times or periods can be employed in connection with the claimed subject matter. For example, consider a fast food restaurant (e.g., vendor 114) who offers engagement-based incentive 122 relating to upgrading the size of a recently ordered menu meal and/or another engagement-based incentive 122 relating to a discount on a dessert. In the first case, engagement-based incentive 122 might become redeemable immediately upon receipt and expire in, say, 2 minutes or so, whereas in the second case, engagement-based incentive 122 can become active in about 5 minutes and expire in about 30 minutes. As another example, consider vendors 114 at a boat, car, or trade show, or a weekend event such as a flea market or the like. In these situations, shopper 106 is likely to spend a good portion of the day in shopping pursuits so it should be understood that the window of validity for engagement-based incentive 122 can also be measured in terms of several hours.

It should be understood that promotion component 120 can receive all or portions of relevant data directly from other components described herein (e.g., components 102, 108, 112 . . . ). Additionally or alternatively, promotion component 120 can receive all or portions of relevant data from data store 124. Thus, it is readily apparent that data store 124 can be operatively coupled, either directly or indirectly to some or all components described herein.

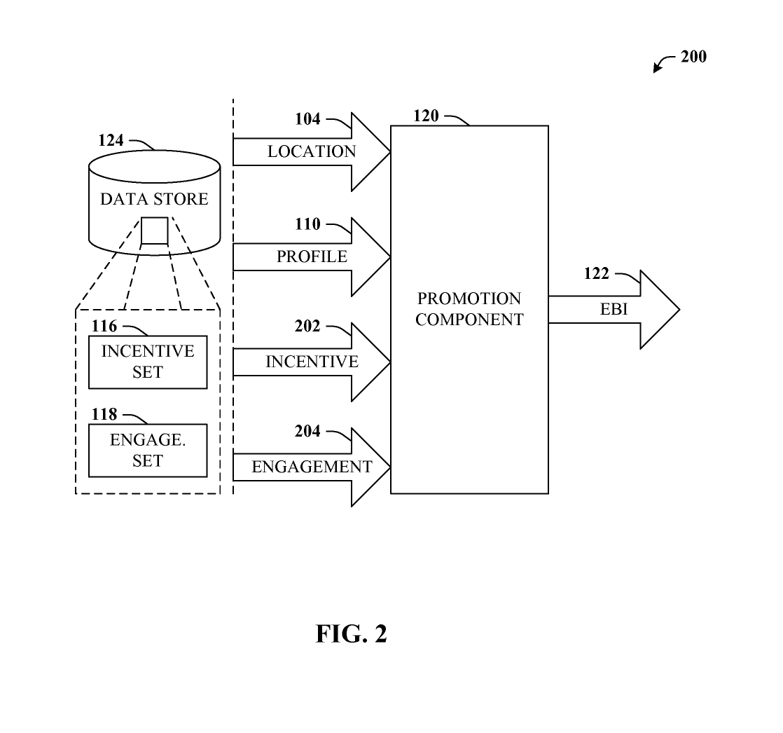

Turning now to FIG. 2, system 200 that illustrates promotion component 120 in further detail can be found. System 200 can include promotion component 120 that can select incentive 202 and engagement 204, and can further combine incentive 202 and engagement 204 to construct engagement-based incentive 122. As described, incentive 202 can be determined to enrich a shopping session or to entertain shopper 106, while engagement 204 can be determined to extend or prolong a shopping session. Both incentive 202 and engagement 204 can be members of respective sets 116, 118 and can be selected at least in part based upon location 104 and profile 110. Moreover, all or portions of sets 116, 118 will typically originate from vendors 114 (e.g. received by communication component 112) and be stored to data store 124 for later access or recall. However in some cases, incentive 202 and/or engagement 204 (as well as portions of sets 116, 118) can be derived independent from vendors 114 yet, e.g. upon authorization, be associated with one or more vendors 114.

For example, a template incentive or engagement can exist that suggests common incentives, engagements, or values or conditions thereof that vendors 114 can agree to without specifically generating or transmitting the given incentive or engagement. One benefit thereof is that template incentives/engagements can be tailored to a particular shopper 106 without the need for supplying personal or private information about shopper 106 to vendors 114. Such templates can be a part of sets 116, 118 and can also be stored to data store 124 as can location 104 and profile 110. As such, promotion component 120 can receive all information necessary for constructing engagement-based incentive 122 from data store 124 as depicted.

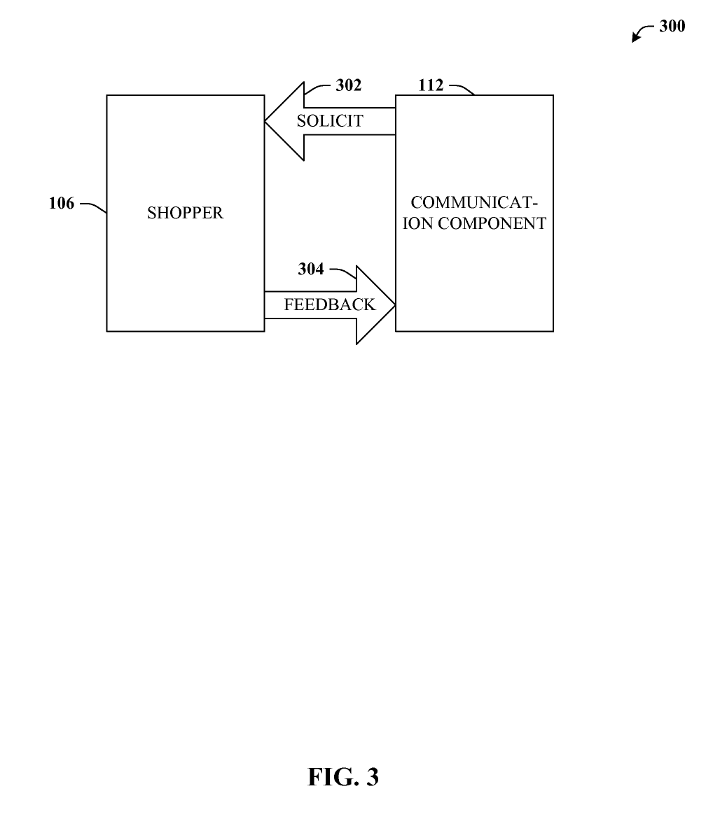

Referring now to FIG. 3, system 300 that can solicit feedback from shopper 106 is presented. In general, system 300 can include communication component 112 that can be operatively or communicatively coupled to an interface or I/O component associated with or local to shopper 106. Communication component 112 can transmit solicitation 302 to shopper 106 (e.g. by way of the associated interface), and receive feedback 304 in response. Solicitation 302 can be included in engagement-based incentive 122. Moreover, according to an aspect, feedback 304 from shopper 106 can be required to satisfy engagement-based incentive 122. For instance, the engagement portion (e.g. engagement 204) can include conditions requiring shopper 106 to submit feedback 304 before receiving or qualifying for the incentive portion (e.g., incentive 202).

As one example, an apparel vendor (e.g., vendor 114) might have a window display portraying one or more outfits. In accordance therewith, engagement-based incentive 122 can indicate at the incentive portion a discount on one or more of the displayed outfits, provided shopper 106 physically visits and/or otherwise views the display and ranks the one or more outfits. Both the visit/view of the display and the ranking can be part of the engagement portion of engagement-based incentive 122, where the ranking can be provided as feedback 304, and can exist as a numeric score, a hot-or-not style ranking, a textual review, and so on. It should be appreciated that feedback 304 is not necessarily limited to opinion-based surveying of shopper 106 and can also include, inter alia, authentication or verification data as to, e.g., identity, transactions, location, or path. For instance feedback 304 can be used to authenticate the identify of shopper 106, to verify shopper 106 made a particular purchase or other transaction, to verify that shopper 106 was at a certain location, perhaps at a certain time or within a certain time period, to verify that shopper 106 traversed a particular route or path, or the like.

In accordance therewith, it is readily apparent that the claimed subject matter can provide rich avenues for entertainment-based engagements that can be incorporated with existing shopping objectives and potentially further encouraged by various incentives. For example, shopper 106 can be encouraged to wander through many areas of a business establishment of vendor 114, being potentially exposed to numerous purchasing or other transaction-based opportunities in a manner that can be not only entertaining or informative, but also scripted in discrete stages to suit various aims.

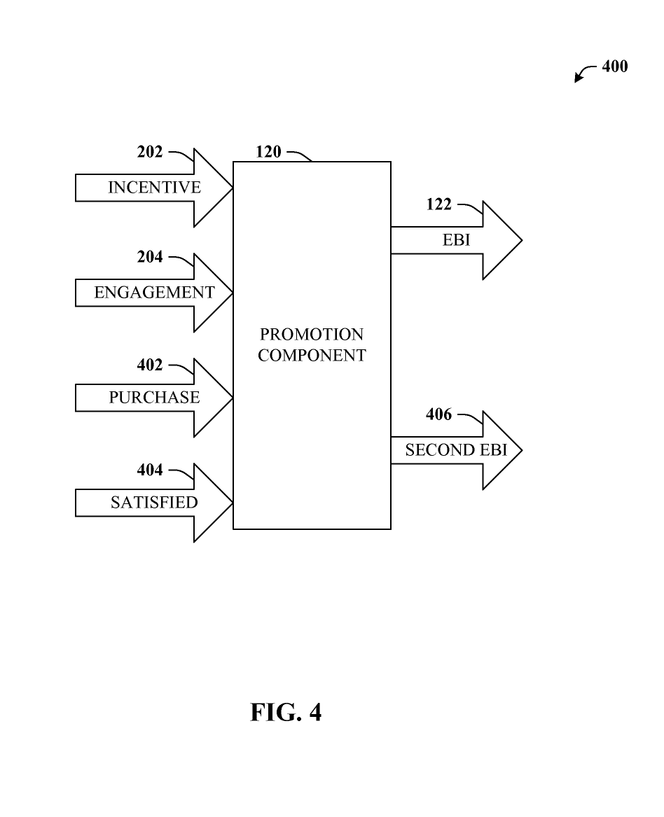

Turning now to FIG. 4, system 400 is provided that illustrates additional features in connection with promotion component 120. Typically, system 400 can include promotion component 120 that can combine incentive 202 and engagement 204 to construct engagement-based incentive 122 as described herein, as well as other suitable components (not shown) detailed herein. In addition, promotion component 120 can construct engagement-based incentive 122 in response purchase 402 by shopper 106. For example, promotion component 120 can receive an indication (e.g., purchase 402) that shopper 106 has made a purchase such as by way of vendor 114 or directly from shopper 106 or an associated device, potentially a mobile device equipped to make or monitor purchasing transactions. Accordingly, information or details related to purchase 402 can be employed to select one or both of incentive 202 or engagement 204 in addition to employing location 104 and profile 110. For example, if purchase 402 relates to a DVD player from an electronics vendor 114, then incentives 202 or engagements 204 related to, say, DVD discs or accessories can be selected. Additionally or alternatively, purchase 402 can be reflected in profile 110 such as in a purchase or transaction history portion of profile 110.

In addition, promotion component 120 can receive indication 404 that engagement-based incentive 122 has been satisfied. Satisfying engagement-based incentive 122 can include one or both of satisfying conditions expressed in the engagement portion, or accepting or realizing the underlying value or utility provided by the incentive portion. Thus, upon occurrence of one or both of these satisfaction criteria, indication 404 can be transmitted to promotion component 120 to indicate engagement-based incentive 122 has been satisfied. In response, promotion component 120 can construct second engagement-based incentive 406 that can further enrich or extend a shopping session of shopper 106. Second engagement-based incentive 406 can be constructed in a manner similar to engagement-based incentive 122. Hence, second engagement-based incentive 406 can employ one or both location 104 or profile 110 for making selections of associated incentives 202 or engagements 204 that can be combined to construct second engagement-based incentive 406, as well as any intervening transactions during the shopping session such as purchases or receipt or issuance of previous engagement-based incentives (e.g., engagement-based incentive 122).

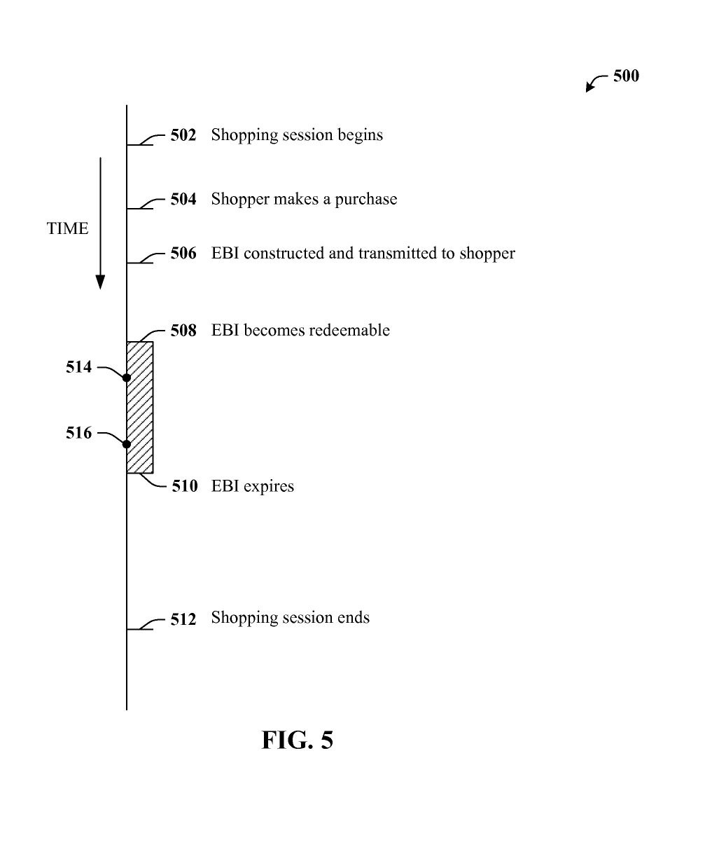

In some cases, second engagement-based incentive 406 can be a logical extension of engagement-based incentive 122 and can account for intervening actions, behavior, transactions, or responses by shopper 106. Moreover, second engagement-based incentive 406 can, but need not necessarily, include an incentive portion that is successively or progressively larger than the incentive portion of engagement-based incentive 122. Thus, at each iteration, as shopper 106 satisfies a previous engagement-based incentive, a subsequent engagement-based incentive can include successively larger incentives. In other cases, however, second engagement-based incentive 406 can be generally unrelated to engagement-based incentive 122 but can be issued as a result of intervening actions, behavior, transactions, or responses of shopper 106, which is further detailed in connection with FIG. 5 infra.

Given that engagement-based incentives 122, 406 can be constructed in response to transactions of shopper 106 (e.g., purchases, satisfaction . . . ), the associated incentive or engagement portions can be related to those transactions. For example, drawing on the above example, shopper 106 purchases a DVD player and subsequently receives engagement-based incentive 122 that can include engagement 204 and incentive 202 from the same electronics vendor 114. For instance, incentive 202 can be a free DVD from vendor 114, provided that shopper 106 returns to the home entertainment department and samples, say, 3 DVD movie trailers from a list provided by, e.g., engagement-based incentive 122, by staff, etc.

However, it should be appreciated that such need not always be the case. For example, the incentive can be unrelated to the previous purchase and can even be directed to a disparate vendor 114. For instance, engagement-based incentive 122 resulting from the DVD purchase can include instead incentive 202 that yields, say, a free espresso from a nearby coffee shop valid for 30 minutes beginning 45 minutes from the time of receipt. Promotion component 120 can make suitable determinations based upon location 104, profile 110, or other suitable factors such as time of day (e.g., nearing lunchtime so shopper 106 might be more inclined to purchase a pastry or deli item in addition to the espresso), an inferred amount of items, bags, or parcels carried (e.g., from previous purchases during the shopping session), and so forth. Thus, about 45 minutes after purchasing the DVD player, shopper 106 can visit the coffee shop, receive a free espresso thereby satisfying engagement-based incentive 122, and then, e.g. receive second engagement-based incentive 406 relating to, say, the free DVD described supra.

With reference now to FIG. 5, example timeline 500 for shopper 106 is provided. At 502, the shopping session begins, e.g., when shopper 106 arrives at a shopping location including one or more vendors 114. At 504, shopper 106 makes a purchase or engages in another suitable transaction. Thereafter, at 506, promotion component 120 can examine location 104, profile 110, information associated with the purchase at 504, and can select incentive 202 and engagement 204. Promotion component 120 can then combine incentive 202 and engagement 204, and can issue the resultant engagement-based incentive 122 to shopper 106.

In this example, the engagement portion of engagement-based incentive 122 includes a time-based element such that engagement-based incentive 122 only becomes redeemable after a period of time, depicted by 508, and expires at a later time, 510. Subsequently, at 512, the shopping session ends, when, for example, shopper 106 returns home. Appreciably, while example 500 relates to physical, geographic based shopping and/or brick-and-mortar vendors 114, corresponding events, transactions, verifications, authentications, incentives 202, engagements 204, engagement-based incentives 122, 406 and so forth can apply in some situations to online shopping as well. For example, the engagement portions of engagement-based incentives 122, 406 can include conditions of web use such as particular providers (e.g., for search, communication, etc.), applications, and so on.

As noted supra, but described in more detail here, second engagement-based incentive 406 can branch directly from engagement-based incentive 122, fostering a chain or tree of dependent engagement-based incentives that can provide successively larger incentives 202 as each is satisfied, as well as potentially evolving into an adventure or sorts, thereby enriching or extending the shopping session of shopper 106. In addition, second engagement-based incentive 406 can be unrelated, generally stemming from intervening activity of shopper 106, but serve to foster an independent chain or tree of engagement-based incentives. These features can be further described in connection with reference numerals 514 and 516.

Again drawing from the previous example, consider shopper 106 who purchases the DVD player at reference numeral 504, and receives engagement-based incentive 122 for a free espresso at 506, which becomes good at 508. As a first example, shopper 106 redeems engagement-based incentive 122 at 514 and receives second engagement-based incentive 406 at 516. For instance, second engagement-based incentive 406 can relate to a return to the home entertainment department for the free DVD, which is a progressively larger reward over the free espresso.

Alternatively, as a second example, shopper 106, for instance en route to the coffee shop, can make an intervening transaction at 514 such as stopping at an ATM or another vendor 114. Such intervening activity at can prompt second engagement-based incentive 406 transmitted at 516 that is independent from engagement-based incentive 122. It should be appreciated that in this case, reference numerals 514 and 516 need not occur during the period of redemption for engagement-based incentive 122 as depicted. It should be further appreciated that shopper 106 might also satisfy engagement-based incentive 122 at the coffee shop, and can thus have multiple engagement-based incentive chains active simultaneously.

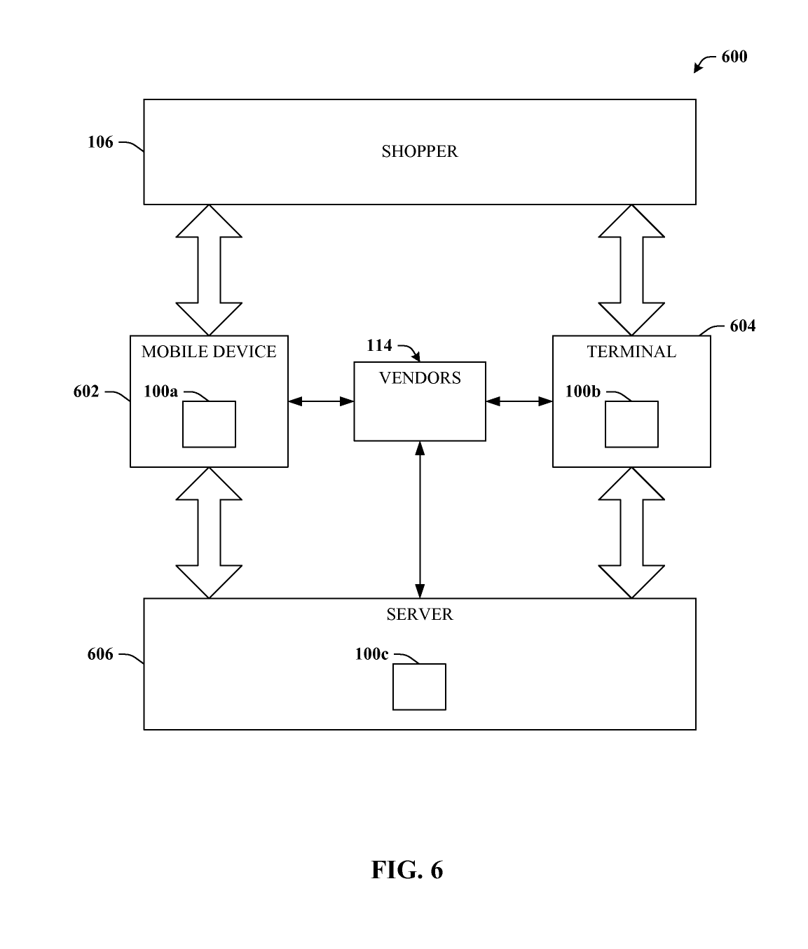

Referring now to FIG. 6, system 600 illustrates various example implementations of system 100. In particular, system 600 can include mobile device 602 such as a mobile device of shopper 106. Mobile device 602 can include an interface or I/O component(s) suitable for communicating data to and from communication component 112. Mobile device 602 can be substantially any portable electronic device such as a phone, a smart phone, a laptop, a tablet, a media player/recorder, a Personal Digital Assistants (PDA), a camera, a game, a fob, and so on. Mobile device 602 can be a handheld device as well as a wearable device and generally includes suitable hardware for one or more types of wireless communication such as cellular, wireless fidelity or “WiFi” (IEEE 802.11x specifications), Bluetooth (IEEE 802.15.x specifications), Near Field Communication (NFC), Radio Frequency Identification (RFID), infrared, etc. It is to be understood that all or portions of system 100 can be included in mobile device 602 as indicated by reference numeral 100a.

Regardless of the type or nature of mobile device 602, it is to be appreciated and understood that the claimed subject matter can provide unique opportunities to promote the use of mobile devices 602 in connection with consumer transactions as well as to employ unique characteristics of mobile devices 602 for additional features, either or both of which can facilitate numerous benefits to the parties involved. For example, purchasing items with mobile device 602 can be much more convenient for shopper 106 by, e.g., avoiding check-out lines. Likewise, such behavior can result in cost savings to vendors 114, given fewer sales employees may be required. In addition, purchases can be verified, potentially providing a beneficial feedback loop in terms of profile 110 (e.g., transaction histories); data such as potentially private or personal data can be mobile as well, yet remain secure or secured; and a wide range of other data aggregations and market targeting techniques can also be employed when mobile devices 602 are used in connection with consumer transactions.

Additionally or alternatively, all or portions of system 100 can be included in terminal 604 as denoted by reference numeral 100b. Terminal 604 can also include an interface or I/O components suitable for transmitting information to and receiving information from communication component 112. Terminal 604 is typically a stationary component and can be, e.g. a kiosk, point-of-sale (POS) or similar type station. By virtue of the stationary nature of terminal 604, location 104 can be readily established when shopper 106 interfaces with terminal 604, such as, e.g., entering a verification code in connection with engagement-based incentives 122, 406, or the like. In addition, terminal 604 can also be a personal computer (PC), including a home PC of shopper 106 or a business PC of vendor 114.

Furthermore, all or portions of system 100 can be included in server 606 as illustrated by reference numeral 100c. Server 606 can be communicatively coupled to at least one of mobile device 602 or terminal 604 by way of a network (not shown) such as a local area network or a wide area network, including distributed networks.

Turning now to FIG. 7, system 700 depicts features of mapping component 102 and profiling component 108 in further detail. In particular, system 700 can include mapping component 102 that can determine location 104 of shopper 106. Mapping component 102 can be aided in such a determination by GPS component 702 that can employ global positioning satellites for well-known location-based services. Similarly, location 104 of shopper 106 can be established by way of a Wireless Application Protocol (WAP) component 704, e.g. in connection with mobile device 602. For instance, radiolocation, triangulation, and/or trilateration, employing signal strength measures at various stationary transceivers and/or signal angle measures and distances by well-known means can be employed to pinpoint shopper 106. Appreciably all or portions of GPS component 702 and WAP component 704 can be included in a disparate device such as mobile device 602. It should be understood that other means exist to aid mapping component 102 in determining location 104 such as RFID, cell sector look-ups for distributed networks or another means described herein or known and suitable for the claimed subject matter.

System 700 can also include profiling component 108 that can select profile 110 for shopper 106. Further to what has been described supra, it should be underscored that profile 110 can be associated with mobile ID 706 of mobile device 602 such as a manufacture ID, product or serial number, or similar identification. Accordingly, profiling component 108 can employ mobile ID 706 to select profile 110, which can be especially beneficial in that mobile device 602 provides an efficient platform for persistent communication with and monitoring/tracking of shopper 106 or associated transactions.

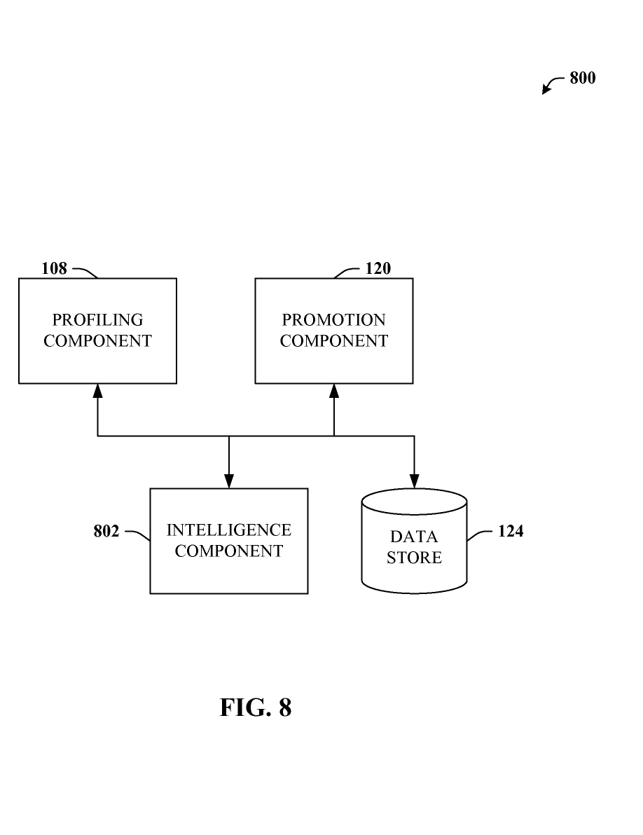

With reference now to FIG. 8, system 800 that can aid with various determinations or inferences is depicted. Typically, system 800 can include profiling component 108 and promotion component 120, which in addition to or in connection with what has been described supra, can also make various inferences or intelligent determinations. For example, profiling component 108 can intelligently associate shopper 106 with a template profile such as when profile 110 does not already exist or cannot be accessed. Moreover, profiling component 108 can also intelligently integrate multiple profiles 110 into a single comprehensive profile 110 (e.g., when shopper is associated with multiple device IDs) as well as intelligently infer shopping preferences or demographic data based upon, e.g., transaction histories or other appropriate data sets.

Likewise, promotion component 120 and can intelligently examine profile 110 as well as intervening activity such as purchases, or employ substantially similar data sets to intelligently select suitable incentives 202 or engagements 204. Promotion component 120 can infer engagements 204 that are most likely to extend the shopping session based upon the particular shopper 106 as well as appropriate incentives 202. Such inferences can be discrete and directed to a single engagement-based incentive 122, or crafted in connection with a series of related engagement-based incentives that are inferred to collectively provide a shopping adventure for shopper 106 that is greater than the sum of the parts (e.g., each successive engagement-based incentive).

In addition, system 800 can also include intelligence component 802 that can provide for or aid in various inferences or determinations. It is to be appreciated that intelligence component 802 can be operatively coupled to all or some of the aforementioned components. Additionally or alternatively, all or portions of intelligence component 802 can be included in one or more of the components 108, 120. Moreover, intelligence component 802 will typically have access to all or portions of data sets described herein or otherwise suitable to the claimed subject matter, such as data store 124, and can furthermore utilize previously intelligently determined or inferred data or results.

Accordingly, in order to provide for or aid in the numerous inferences described herein, intelligence component 802 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, where the hypersurface attempts to split the triggering criteria from the non-triggering events. Intuitively, this makes the classification correct for testing data that is near, but not identical to training data. Other directed and undirected model classification approaches include, e.g. naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

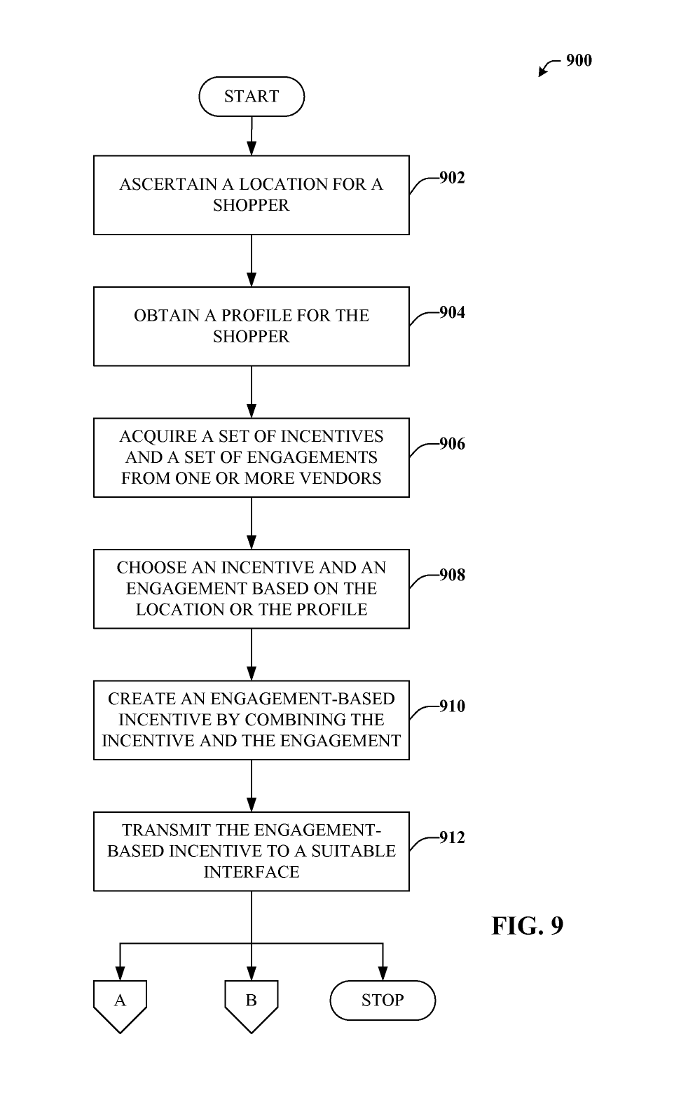

FIGS. 9, 10, 11, and 12 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

With reference now to FIG. 9, exemplary method 900 for generating engagement-based incentives that facilitate prolonging or enhancing a shopping session is illustrated. Generally, at reference numeral 902, a location for a shopper can be ascertained. Appreciably, the location can be ascertained by way of signaling related to a mobile device such as GPS, WAP, infrared, RFID and so on. Additionally or alternatively, the location can be ascertained when shopper interfaces a terminal such as a kiosk or POS station or the like.

At reference numeral 904, a profile for the shopper can be obtained. Such can be accomplished, e.g., by obtaining an ID associated with the shopper, either input by the shopper or transmitted, potentially automatically or as an acknowledgement or response to a query, by an associated device, including an ID associated with the device. In an aspect, the profile can be newly created, potentially employing a template profile that includes common features of identifiable shopper types, potentially based upon a location of the shopper, behavior of the shopper, time, visual indicia, and any other suitable data that can be observed or inferred.

At reference numeral 906, a set of incentives and a set of engagements can be acquired from one or more vendors. For example, vendors can submit suitable incentives that can be allocated to potential customers typically utilized to entice transactions or desired behavior, such as coupons, rebates, prizes, etc. Likewise, vendors can submit engagements that can relate to or describe displays or promotions or desired shopper behavior. Appreciably, the submitted incentives and engagements need not be directly related.

At reference numeral 908, an incentive from the set of incentives and an engagement from the set of engagements can be chosen based at least in part upon the location ascertained at act 902 and/or the profile obtained at act 904. It should be understood that either the incentive or the engagement can be chosen based upon other additional information as well, such as based upon previous transactions or shopper behavior. At reference numeral 910, an engagement-based incentive can be created by combining the chosen incentive with the chosen engagement. At reference numeral 912, the engagement-based incentive can then be transmitted to a suitable interface local to the shopper and displayed.

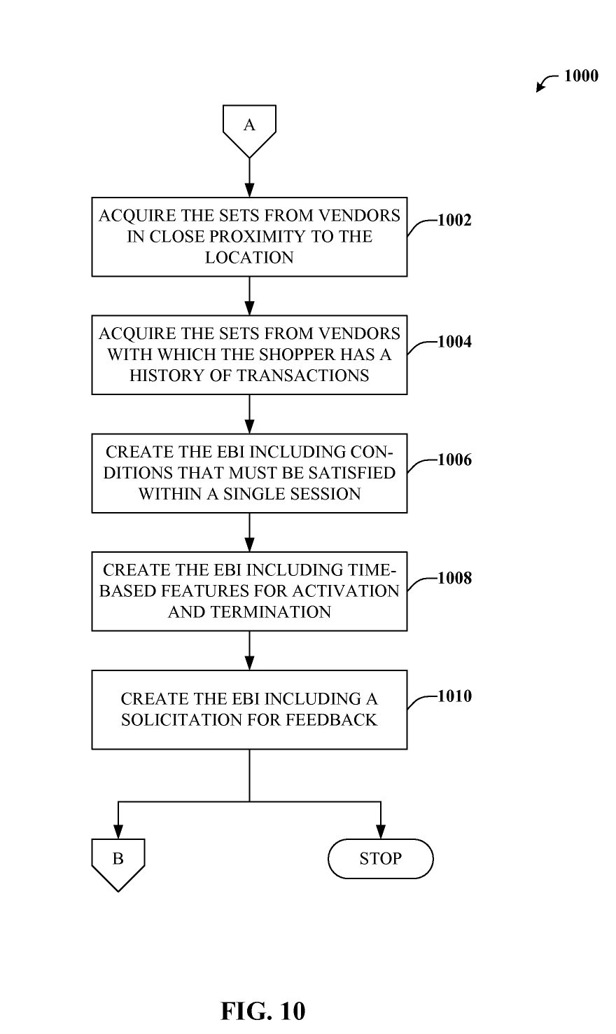

Referring to FIG. 10, exemplary method 1000 for employing additional features for creating the engagement-based incentive is depicted. To these and other related ends, at reference numeral 1002, the set of incentives and the set of engagements (e.g. the sets acquired at act 906) can be acquired from vendors in relatively close proximity to the location ascertained at act 902. Proximity to the location can be based strictly upon geographical factors or included time-based criteria such as travel time to the vendor given available modes of travel.

Similarly, at reference numeral 1004, the set of incentives and the set of engagements can be acquired from vendors with which the shopper has a history of transactions. The history of transactions for the shopper can be included in the profile obtained at act 904 or can be obtained at least in part from recent transactions or intervening activity of the shopper within a current shopping session.

At reference numeral 1006, the engagement-based incentive created at act 910 can be created including conditions that must be satisfied within a single shopping session. It should be understood that such conditions need not be expressly directed to a single shopping session, but rather can be directed to conditions that generally assure or make it more likely or more convenient that the conditions will be satisfied in a single shopping session. An example of such can be a condition that stipulates relevant time periods, such as that described at reference numeral 1008, wherein the engagement-based incentive can include an engagement that activates about 30 minutes after the act of transmitting detailed at reference numeral 912, and that terminates about 90 minutes after the act of transmitting.

At reference numeral 1010, the engagement-based incentive created at act 910 can include a solicitation for feedback from the shopper that must be received in order to satisfy the engagement. For example, the feedback can require the shopper to rank a product, service, advertisement, display, etc. of one or more vendors. As another example, the feedback can be a response or verification code such as a response to a question, trivia, a puzzle, or a verification code that proves the shopper met some challenge or criteria such as a transaction/purchase receipt or ID or presence verification.

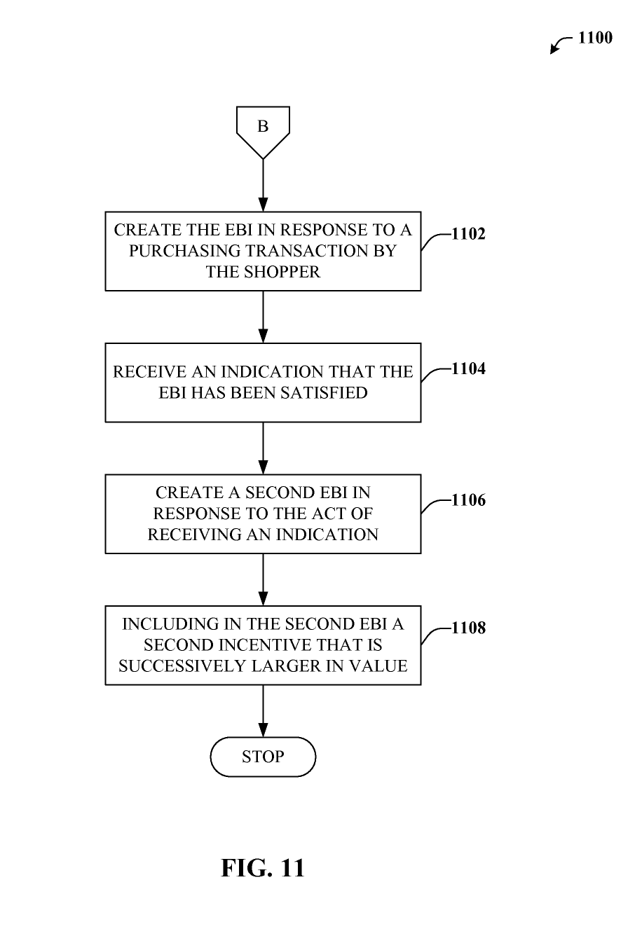

With reference now to FIG. 11, method 1100 for constructing a second engagement-based incentive in order to facilitate extending or enriching a shopping session is illustrated. In general, at reference numeral 1102, the engagement-based incentive created at act 910 can be in response to a purchasing (or another type of) transaction by the shopper. For example, receiving an indication of a purchase made by shopper 106 can be a fruitful manner of establishing that the shopper is in the midst of a shopping session (and may therefore be more responsive or receptive to engagement-based incentives) rather than attempting to establish or infer such in another way (e.g. based upon location, profile, or suitable combinations thereof).

At reference numeral 1104, an indication that the engagement-based incentive has been satisfied can be received. For instance the indication can detail or verify that all or substantial parts of the conditions of the engagement portion have been met and/or that the incentive has been delivered to the shopper. At reference numeral 1106, a second engagement-based incentive can be created in response to the act of receiving an indication described at act 1104. At reference numeral 1108, the second engagement-based incentive can include a second incentive portion that is successively larger in value than the incentive portion of the original engagement-based incentive.

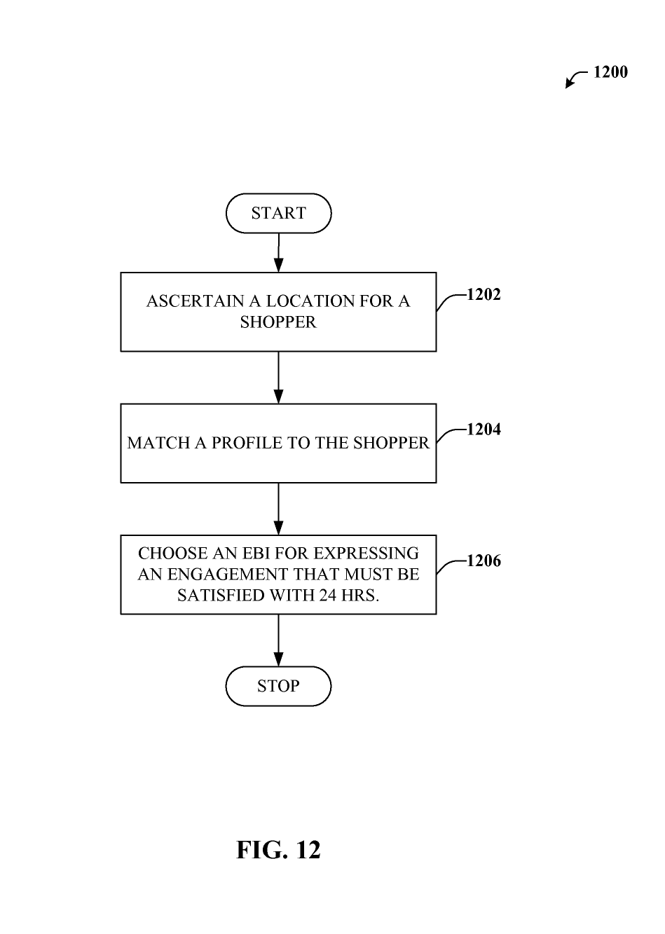

Turning now to FIG. 12, exemplary method 1200 for providing engagement-based incentives that facilitate prolonging or enhancing a shopping session is depicted. Typically, at reference numeral 1202, a location for a shopper can be ascertained. Appreciably, the location can be ascertained by way of signaling in connection with a mobile device that employs, e.g. GPS, WAP, infrared, RFID and so on. Additionally or alternatively, the location can be ascertained when shopper interfaces a terminal such as a kiosk or POS station or the like.

At reference numeral 1204, a profile can be matched to the shopper. Such can be accomplished, e.g., by obtaining an ID associated with the shopper, either input by the shopper or transmitted, potentially automatically or as an acknowledgement or response to a query, by an associated device, including an ID associated with the device. Appreciably, the profile can be newly created, potentially employing a template profile that includes common features of identifiable shopper types, potentially based upon a location of the shopper, behavior of the shopper, time, visual indicia, and any other suitable data that can be observed or inferred.

At reference numeral 1206, an engagement-based incentive can be chosen for the shopper based upon at least one of the location or the profile obtained at acts 1202 and 1204, respectively. The engagement-based incentive can include a suitable incentive such as a reward or discount, and can further include an engagement that must be satisfied substantially within a 24-hour period in order to receive the incentive.

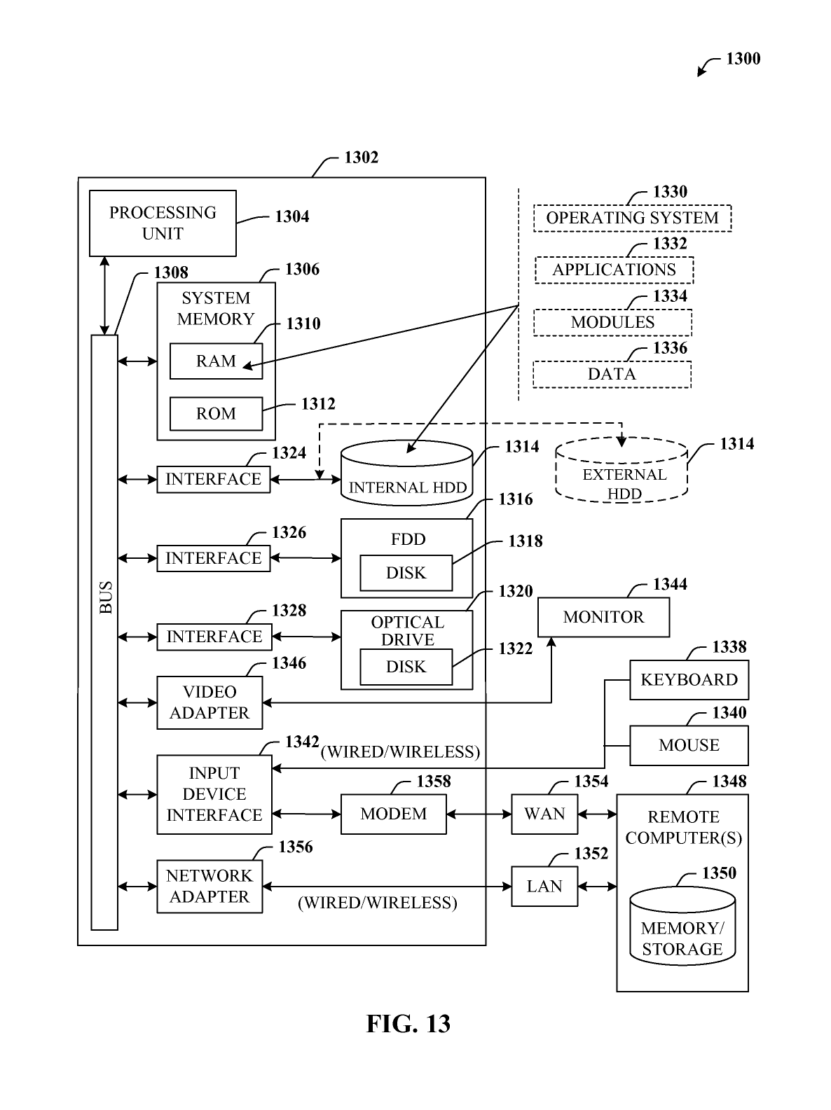

Referring now to FIG. 13, there is illustrated a block diagram of an exemplary computer system operable to execute the disclosed architecture. In order to provide additional context for various aspects of the claimed subject matter, FIG. 13 and the following discussion are intended to provide a brief, general description of a suitable computing environment 1300 in which the various aspects of the claimed subject matter can be implemented. Additionally, while the claimed subject matter described above may be suitable for application in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 13, the exemplary environment 1300 for implementing various aspects of the claimed subject matter includes a computer 1302, the computer 1302 including a processing unit 1304, a system memory 1306 and a system bus 1308. The system bus 1308 couples to system components including, but not limited to, the system memory 1306 to the processing unit 1304. The processing unit 1304 can be any of various commercially available processors. Dual microprocessors and other multi-processor architectures may also be employed as the processing unit 1304.

The system bus 1308 can be any of several types of bus structure that may further interconnect to a memory bus (with or without a memory controller), a peripheral bus, and a local bus using any of a variety of commercially available bus architectures. The system memory 1306 includes read-only memory (ROM) 1310 and random access memory (RAM) 1312. A basic input/output system (BIOS) is stored in a non-volatile memory 1310 such as ROM, EPROM, EEPROM, which BIOS contains the basic routines that help to transfer information between elements within the computer 1302, such as during start-up. The RAM 1312 can also include a high-speed RAM such as static RAM for caching data.

The computer 1302 further includes an internal hard disk drive (HDD) 1314 (e.g., EIDE, SATA), which internal hard disk drive 1314 may also be configured for external use in a suitable chassis (not shown), a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as the DVD). The hard disk drive 1314, magnetic disk drive 1316 and optical disk drive 1320 can be connected to the system bus 1308 by a hard disk drive interface 1324, a magnetic disk drive interface 1326 and an optical drive interface 1328, respectively. The interface 1324 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 1302, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. It is appreciated that the claimed subject matter can be implemented with various commercially available operating systems or combinations of operating systems.

A user can enter commands and information into the computer 1302 through one or more wired/wireless input devices, e.g. a keyboard 1338 and a pointing device, such as a mouse 1340. Other input devices (not shown) may include a microphone, an IR remote control, a joystick, a game pad, a stylus pen, touch screen, or the like. These and other input devices are often connected to the processing unit 1304 through an input device interface 1342 that is coupled to the system bus 1308, but can be connected by other interfaces, such as a parallel port, an IEEE1394 serial port, a game port, a USB port, an IR interface, etc.

A monitor 1344 or other type of display device is also connected to the system bus 1308 via an interface, such as a video adapter 1346. In addition to the monitor 1344, a computer typically includes other peripheral output devices (not shown), such as speakers, printers, etc.

The computer 1302 may operate in a networked environment using logical connections via wired and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wired/wireless connectivity to a local area network (LAN) 1352 and/or larger networks, e.g. a wide area network (WAN) 1354. Such LAN and WAN networking environments are commonplace in offices and companies, and facilitate enterprise-wide computer networks, such as intranets, all of which may connect to a global communications network, e.g. the Internet.

When used in a LAN networking environment, the computer 1302 is connected to the local network 1352 through a wired and/or wireless communication network interface or adapter 1356. The adapter 1356 may facilitate wired or wireless communication to the LAN 1352, which may also include a wireless access point disposed thereon for communicating with the wireless adapter 1356.

When used in a WAN networking environment, the computer 1302 can include a modem 1358, or is connected to a communications server on the WAN 1354, or has other means for establishing communications over the WAN 1354, such as by way of the Internet. The modem 1358, which can be internal or external and a wired or wireless device, is connected to the system bus 1308 via the serial port interface 1342. In a networked environment, program modules depicted relative to the computer 1302, or portions thereof, can be stored in the remote memory/storage device 1350. It will be appreciated that the network connections shown are exemplary and other means of establishing a communications link between the computers can be used.

The computer 1302 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 13 Mbps (802.11b) or 54 Mbps (802.11a) data rate, for example, or with products that contain both bands (dual band), so the networks can provide real-world performance similar to the basic “10BaseT” wired Ethernet networks used in many offices.

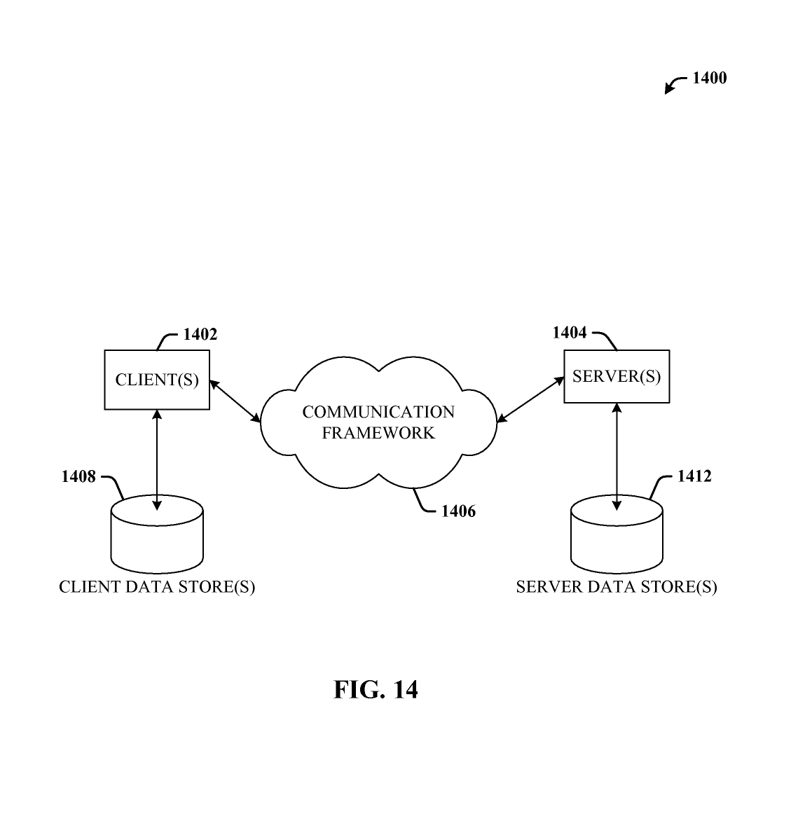

Referring now to FIG. 14, there is illustrated a schematic block diagram of an exemplary computer compilation system operable to execute the disclosed architecture. The system 1400 includes one or more client(s) 1402. The client(s) 1402 can be hardware and/or software (e.g., threads, processes, computing devices). The client(s) 1402 can house cookie(s) and/or associated contextual information by employing the claimed subject matter, for example.

The system 1400 also includes one or more server(s) 1404. The server(s) 1404 can also be hardware and/or software (e.g., threads, processes, computing devices). The servers 1404 can house threads to perform transformations by employing the claimed subject matter, for example. One possible communication between a client 1402 and a server 1404 can be in the form of a data packet adapted to be transmitted between two or more computer processes. The data packet may include a cookie and/or associated contextual information, for example. The system 1400 includes a communication framework 1406 (e.g., a global communication network such as the Internet) that can be employed to facilitate communications between the client(s) 1402 and the server(s) 1404.

Communications can be facilitated via a wired (including optical fiber) and/or wireless technology. The client(s) 1402 are operatively connected to one or more client data store(s) 1408 that can be employed to store information local to the client(s) 1402 (e.g., cookie(s) and/or associated contextual information). Similarly, the server(s) 1404 are operatively connected to one or more server data store(s) 1410 that can be employed to store information local to the servers 1404.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that provides engagement-based incentives intended to extend or enrich a shopping session, comprising:
a mapping component that determines a location of a shopper;
a profiling component that selects a profile for the shopper;
a communication component that receives from one or more vendors a set of engagements and a set of incentives; and
a promotion component that selects, based at least in part upon the location or the profile, an incentive from the set of incentives and an engagement from the set of engagements, the promotion component combines the incentive and the engagement to construct an engagement-based incentive for the shopper that expires within 24 hours, and the communication component transmits the engagement-based incentive to an I/O component proximal to the shopper.

2. The system of claim 1, the engagement-based incentive includes conditions that must be satisfied within a single shopping session.

3. The system of claim 1, the engagement-based incentive becomes redeemable about 30 minutes after, and expires about 90 minutes after, the communication component transmits the engagement-based incentive to the I/O component.

4. The system of claim 1, the engagement-based incentive solicits feedback from the shopper that must be received to satisfy the engagement.

5. The system of claim 1, the promotion component selects the incentive in order to entertain the shopper or to enrich a shopping session.

6. The system of claim 1, the promotion component selects the engagement in order to extend a shopping session of the shopper.

7. The system of claim 1, the promotion component constructs the engagement-based incentive in response to a purchase by the shopper, and further selects at least one of the incentive or the engagement based upon information that relates to the purchase.

8. The system of claim 1, the promotion component receives an indication that the engagement-based incentive has been satisfied.

9. The system of claim 1, the promotion component constructs a second engagement-based incentive.

10. The system of claim 9, the second engagement-based incentive includes a second incentive that is progressively larger in terms of value than the incentive included in the previously satisfied engagement-based incentive.

11. The system of claim 1 is included in a mobile device.

12. The system of claim 1 is included in a stationary terminal in proximity to the one or more vendors.

13. The system of claim 1 is included in a server that is communicatively coupled to at least one of a mobile device or a stationary terminal in proximity to the one or more vendors.

14. The system of claim 1, the mapping component determines the location based upon information received from a Global Positioning Satellite (GPS) component.

15. The system of claim 1, the mapping component determines the location based upon information received from a wireless application protocol (WAP) component.

16. The system of claim 1, the profiling component selects the profile based upon a mobile device ID.

17. A method for constructing engagement-based incentives that facilitate prolonging or enhancing a shopping session, comprising:
ascertaining a location for a shopper;
obtaining a profile for the shopper;
acquiring a set of incentives and a set of engagements from one or more vendors;
choosing an incentive from the set of incentives and choosing an engagement from the set of engagements, the choosing is based at least in part upon the location or the profile; and
creating an engagement-based incentive by combining the incentive and the engagement; and
transmitting the engagement-based incentive to an interface local to the shopper for display.

18. The method of claim 17, further comprising at least one of the following acts:
ascertaining the location for the shopper based upon information received from at least one of a GPS component or a WAP component;
obtaining the profile for the shopper based upon a mobile device ID;
acquiring the set of incentives and the set of engagements from vendors in close proximity to the location;
acquiring the set of incentives and the set of engagements from vendors with which the shopper has a history of transactions;
creating the engagement-based incentive including conditions that must be satisfied within a single shopping session;
creating the engagement-based incentive including the engagement activating immediately after the act of transmitting and terminating about 2 minutes after the act of transmitting;
creating the engagement-based incentive including the engagement activating about 5 minutes after the act of transmitting and terminating about 30 minutes after the act of transmitting;
creating the engagement-based incentive including the engagement terminating between about 4 to 12 hours after the act of transmitting;
creating the engagement-based incentive including the engagement activating about 30 minutes after the act of transmitting and terminating about 90 minutes after the act of transmitting; or
creating the engagement-based incentive including a solicitation for feedback that must be received in order to satisfy the engagement.

19. The method of claim 17, further comprising at least one of the following acts:
creating the engagement-based incentive in response to a purchasing transaction by the shopper;
receiving an indication that the engagement-based incentive has been satisfied;
creating a second engagement-based incentive in response to the act of receiving an indication; or
including in the second engagement-based incentive a second incentive that is successively larger in value than the incentive.

20. A method for providing engagement-based incentives that facilitate prolonging or enhancing a shopping session, comprising:
ascertaining a location of a shopper;
matching a profile to the shopper;
choosing an engagement-based incentive for the shopper based upon at least one of the location or the profile, the engagement-based incentive including an incentive and expressing an engagement that must be satisfied substantially within a 24-hour period in order to receive the incentive.
